(19) United States
(12) Patent Application Publication
(10) Pub. No.: US 2006/0271424 A1
(43) Pub. Date: Nov. 30, 2006

(54) System and method for sponsored document processing services

(75) Inventors: Fabio M. Gava, Ladera Ranch, CA (US); Jason Wei, Irvine, CA (US); Mohammad A. Suleiman, Trabuco Canyon, CA (US); Harpreet Singh, Orange, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignee: Toshiba Corporation and Toshiba Tec Kabushiki Kaisha

(21) Appl. No.: 11/138,566

(22) Filed: May 26, 2005

(51) Int. Cl. G06Q 30/00

(52) U.S. Cl. 705/14

(57) ABSTRACT

A method and system for enabling the sponsorship of document processing services. A document processing service request is submitted by an associated user. At least one sponsor, associated with the document processing service request is then identified and communicated to the user. Terms and conditions regarding the sponsorship of the request are then presented to the user for acceptance. The terms and conditions include restrictions on the number of pages, size and color, as well as the placement of an advertisement on the output. The advertisement is in the form of a banner, watermark or reverse-side image. Once accepted, the advertisement is inserted into the request and the selected operation is performed. The fees associated with the request are then calculated and charged to the sponsor. When only partial payment is authorized by the sponsor, the user is charged for the remaining fees.

### BACKGROUND OF THE INVENTION

This invention is directed to a system and method for providing data services. More particularly, this invention is directed to a system and method for providing sponsored document processing services.

Document processing services are often provided in non-office or public environments, such as airports, hotels, or retail establishments, to propagate or generate electronic documents. Users of such document processing services pay for the services by various means known in the art. For example, user may access a document processing device and pay for document processing operations directly via a credit card or cash. The user may also pay for document processing services indirectly, via a customer account or other suitable payment method known in the art.

These document processing services are often expensive. Toner, equipment, storage space, power, and a variety of other factors play an important part in determining the appropriate fee for a given document processing service. Current expenses regarding the use of such remote devices prohibit the majority of users from taking advantage of the services offered. Therefore, if a user were only able to access the services while incurring minimal or no costs, the number of users taking advantage of the services would increase dramatically.

There is a need for a system and method for providing sponsored document processing services to a user.

### SUMMARY OF THE INVENTION

In accordance with the present invention, there is provided a system and method for providing document processing services.

Further, in accordance with the present invention, there is provided a system and method for providing sponsored document processing services to a user.

Still further, in accordance with the present invention, there is provided a system and method for providing discounted document processing services to a user via sponsor-based document processing devices.

Still further, in accordance with the present invention, there is provided a method for enabling sponsorship of document processing services. Data representing a document processing request to be performed on an associated electronic document is received from an associated user. Each sponsor associated with the received document processing request is the identified. Sponsor data representing those identified sponsors is then communicated to the user. Document processing instructions for completing the document processing request are then received from the user including the sponsorship activity. The document processing request is then completed in accordance with the sponsorship activity.

Still further, in accordance with the present invention, there is provided a system for enabling sponsorship of document processing services. The system includes means adapted for receiving, from an associated user, data representing a selected document processing request to be performed on an associated, electronic document and identification means adapted for identifying each sponsor associated with the received document processing request. The system also includes communication means adapted for selectively communicating, to the associated user, sponsor data representing at least one sponsor identified with the selected document processing request and means adapted for receiving, from the associated user, document processing instructions for completing the document processing request. The document processing instructions include at least one sponsorship activity. In addition, the system also comprises processing means adapted for selectively completing the document processing request in accordance with the at least one sponsorship activity.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description, serve to explain the principles of the invention.

FIG. 1 is a block diagram illustrating a system in accordance with the present invention;

FIG. 2 is a flow chart illustrating a method in accordance with the present invention;

FIG. 3 is a flow chart illustrating a sponsor selection in accordance with the present invention;

FIG. 4A is a block diagram illustrating a banner sponsor image position in accordance with the present invention;

FIG. 4B is a block diagram illustrating a watermark sponsor image position in accordance with the present invention;

FIG. 4C is a block diagram illustrating a reverse-side sponsor image position in accordance with the present invention; and

FIG. 5 is a flow chart illustrating a fee-based method in accordance with the present invention.

### DETAILED DESCRIPTION OF THE PREFERRED EMBODIMENT

The present invention is directed to a system and method for providing document processing services. More particularly, the present invention is directed to a system and method for providing discounted document processing services to a mobile user via sponsor-based document processing devices.

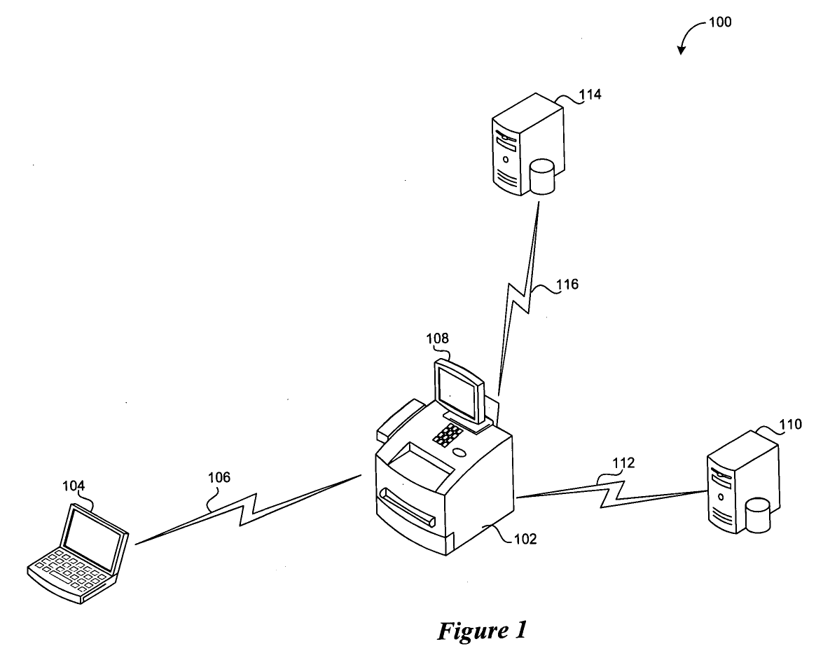

Turning now to FIG. 1, there is shown a diagram illustrating the system 100 in accordance with the present invention. As shown in FIG. 1, a user is able to access a document processing device, illustrated by a multifunction peripheral device 102, to generate or process image data. Those skilled in the art will appreciate that the document processing device is any suitable document processing device known in the art, such as a copier, printer, scanner, facsimile and the like, or any combination thereof. Suitable commercially available document processing peripherals include, but are not limited to, the Toshiba e-Studio Series Controller.

In the preferred embodiment, the user accesses the device 102 in a non-office environment, such as an airport lounge, a business center, mall kiosk, library, conference center, university campus, and the like. Preferably, the device 102 is located in a retail establishment that partial subsidizes the costs of transactions conducted on the device, as will be explained in more detail below. More preferably, the user accesses the device 102 directly or via a computer or other suitable interface, illustrated in FIG. 1 as a notebook computer 104 via a suitable communications link 106. As will be understood by those skilled in the art, the communications link 106 is any means for communication between electronic devices, including for example and without limitation, an Ethernet based network, infrared connection, Wi-Fi connection, telephone connection, cellular connection, Bluetooth connection and the like or any combination of communication means thereof. The user is also capable of accessing the multifunction peripheral device 102 directly via the communicatively coupled interface 108. In the preferred embodiment, the interface 108 is a touch screen interface, however any other suitable means of user interaction, such as an alphanumeric keypad or mouse are equally capable of being employed to receive instructions from the user.

The multifunction peripheral device is also preferably connected to an associated backend database server 110 via a suitable communications link 112. The backend database 110 suitably includes data regarding user account information, sponsor account information, sponsor image files and advertisements or coupons, sponsor restriction elements and the like. The skilled artisan will appreciate that the database server 110 is suitably used to supply consumer and sponsor information to the multifunction peripheral device 102 via the communications link 102. Preferably, the database server 110 is located remotely from the device 102, and is capable of supplying such data to a plurality of document processing devices at a respective plurality of locations. For explanatory purposes, the preferred embodiment discusses application of a single device at a single location. The skilled artisan will appreciate that more than one device is capable of being implemented at the same location, without departing from the scope of the present invention.

In the preferred embodiment, the multifunction peripheral device 102 is also communicatively coupled to a backend file storage device 114 via a communications link 116. The backend file storage server 114 is capable of storing a variety of files in different formats and receiving or transmitting these files to the device 102. Thus, during operation of the multifunction peripheral device 102, a user is able to save or store a scan job on the backend file storage server 114 for later retrieval. Alternatively, a user is able to upload a file to the backend file storage server 114 from his home or office and when traveling, approach the device 102 and retrieve the desired file from the backend file server 114 via the communications link 116 for further document processing operations. In one embodiment, the backend file storage device 114 is advantageously a part of the multifunction peripheral device 102, such as a hard disk drive and the like. The skilled artisan will appreciate that the user device 104 and the interface 108 are equally capable of being manipulated by the user to locate and retrieve or store an electronic file.

The system 100 provides a user with a subsidized method for payment of fees incurred during use of a document processing device. When a user has the need to use a multifunction peripheral device 102 for document processing operations, the user enters any establishment having a publicly accessible device 102. The multifunction peripheral device 102 is then accessed by the user via the interface 106 or alternatively, the user's notebook computer 104. Each of the services offered by the multifunction peripheral device 102 has an associated fee for completion of the corresponding service. The user is expected to make such payment either before initiation of processing or in the case of a user account, following completion of the service. The services available on the device 102 are suitably sponsored completely or in part by one or more sponsors, e.g., advertisers. In exchange for sponsoring document processing operations on the multifunction peripheral device 102, the sponsor receives space on each document generated in which to add an advertisement.

When a user requires, for example, to generate a document, the device 102 queries the backend database server 110 to determine if the requested document processing operation is one for which a sponsor has agreed to offset the price of the transaction. When a sponsor is available, restriction elements are retrieved from the database 110 which set forth the terms and conditions to use the offset pricing available on the device 102. Should a sponsor of the location not be found, operation of the device will follow typical fee-based transactions, as known in the art. The restrictions required by the sponsoring entity are capable of including, but are not limited to, the number of pages in the document processing request, the size of paper, the colors or toners required, and the like. The terms and conditions include, for example and without limitation, payment of the remaining charges in the event of partial payment by the sponsor, agreeing to the placement of a watermark on the outputted copies, a banner advertisement on the face of the outputted copies, or an advertisement on the back of each page of the outputted copies. The skilled artisan will appreciate that advertisements and/or watermarks are any suitable commercial message desired by the sponsoring entity.

When the user agrees to the terms and conditions, and the requested copy operation meets the restrictions established by the sponsoring entity, the device 102 outputs the document processing job with the advertisements. For example, if the sponsor has selected banner advertising, the multifunction peripheral device shrinks or sizes-to-fit the original document to an appropriate size to allow placement on the page or pages of the banner message, such as sponsor's logo or coupon. If the sponsor has stipulated placement of a watermark on the outputted copies, the device 102 combines a watermark image file, retrieved from the database 1 10, and outputs the combined document. Alternatively, if the sponsor requested placement of a reverse-side, i.e., back face of the paper, the device 102 outputs the commercial advertisement on the reverse side of the paper.

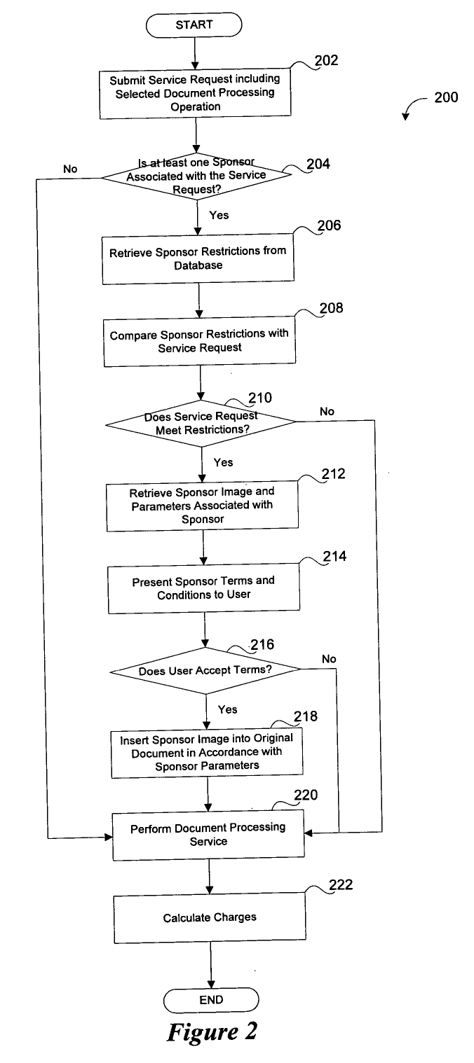

As will be understood by those skilled in the art, the user is able to copy, print, fax, or scan an original document using the multifunction peripheral device for little or no price. When the device 102 is sponsored by more than one sponsoring entity, e.g., the hotel, coffee shop and an office supply store, the entities are alternately selected in a round-robin fashion, to sponsor a user. The method employed by the system 100 will better be understood in connection with the flowchart 200 illustrated in FIG. 2.

Referring now to FIG. 2, there is depicted an exemplary flowchart 200 illustrating one embodiment of the method in accordance with the present invention. The method begins at step 202 with the submittal of a service request by a user. In the preferred embodiment, the service, or job request, includes the selection of one or more document processing operations capable of being performed by the multifunction peripheral device 102. A determination is then made at step 204 that at least one sponsor is associated with the submitted document processing request. In the event that there are no sponsors are available, flow proceeds to step 220, where the document processing service is performed. In one embodiment, the service request is associated with a specific device. In an alternate embodiment, the service request is associated with a specific location. In yet another embodiment, the service request is suitably associated with a specific type of document processing operation, e.g., print, scan, copy, fax, store, email, and the like. For example, a sponsor agrees to offset or fully pay for copying, printing and scanning, but will not pay for facsimile or email transactions. As an additional example, a second sponsor, associated with the location at which the user seeks to procure document processing operations fully pays for all facsimile, email, printing and scanning, but only on a specific machine. When no sponsor is available, flow proceeds to step 220, where the document processing service is performed.

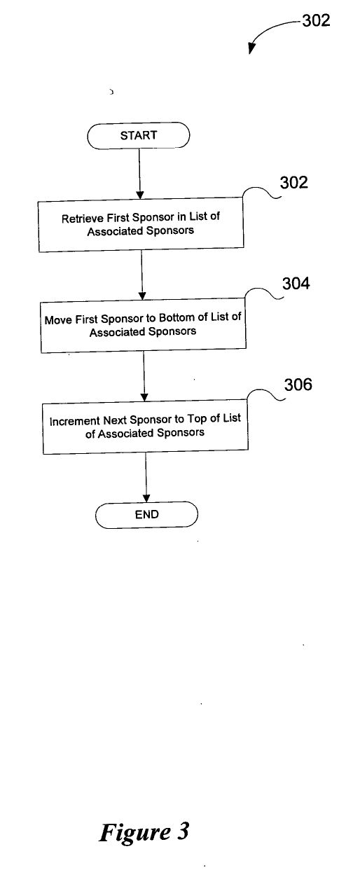

When at least one sponsor has been located, flow proceeds to step 206 wherein sponsor restrictions are retrieved by the device 102 from the backend database server 110. For circumstances where more than one sponsor is associated with a particular location, a sponsor is selected in the round-robin fashion discussed above, and the selected sponsor's restrictions are retrieved from the database 110. Selection of a sponsor will better be understood in connection with the flowchart 300 of FIG. 3. As illustrated in FIG. 3, a first sponsor is retrieved from a list of associated sponsors from the database 110 at step 302. At step 304, the retrieved sponsor is moved from the top of the list to the bottom of the list. The next sponsor is then incremented upwards to the top of the list at step 306, wherein the next service request will trigger retrieval of this sponsor and the method will repeat. Once all sponsors have sponsored an operation, the list resets and the first sponsor is again moved to the top of the list.

Returning to FIG. 2, the sponsor restrictions are compared with the submitted service request at step 208 and a determination is made at step 210 that the submitted request complies with the restrictions set forth by the sponsor. For example, the number of pages in the original document is less than or equal to the maximum number of pages for which the sponsor is willing to pay. In the context of a scan request, the size of the scanned document will not exceed the maximum size limit for which the sponsor is willing to pay. When the service request fails to meet the restrictions, flow proceeds to step 220, wherein document processing services are performed.

Following the assertion that the service request meets the restrictions, the sponsor's image file, text file or other electronic file pertaining to the advertisement to be included in any output document, is retrieved from the database 110 at step 212, along with associated parameters. For example, the retrieved sponsor image file is capable of being a logo, an advertisement, a coupon, or other commercial or service type message known in the art. As will be understood by those skilled in the art, the associated parameters suitably include, but are not limited to, paper size, toner levels, colors, resolution, and the like. At step 214, the sponsor's terms and conditions are presented to the user. As will be appreciated by those skilled in the art, the terms and conditions include, but are not limited to, acceptance of the placement of advertisements on the outputs, number of copies, content of original document, usage requirements, and the like. As will be appreciated by those skilled in the art, when only partial payment for the services will be made by the sponsor, the user is informed at step 214 that in addition to the placement of advertisements on the outputted documentation, the user will incur additional charges in excess of the sponsored amount.

A determination is then made at step 216 that the user accepts the terms and conditions for using the sponsored document processing services. When the user determines that the terms and conditions for sponsored use are unacceptable, flow proceeds to step 220 and document processing services are then performed. Following acceptance by the user of the sponsor's terms and conditions, the retrieved sponsor image is then inserted into the scanned original document in accordance with the sponsor parameters at step 218. The skilled artisan will appreciate that the parameters are capable of including, but are not limited to, location of the advertisement on the output copies, paper size of the output copies, toner levels, finishing options and the like. Document processing services are then performed at step 220 and the document containing the original document and the sponsor image is output in accordance with the selected document processing operation.

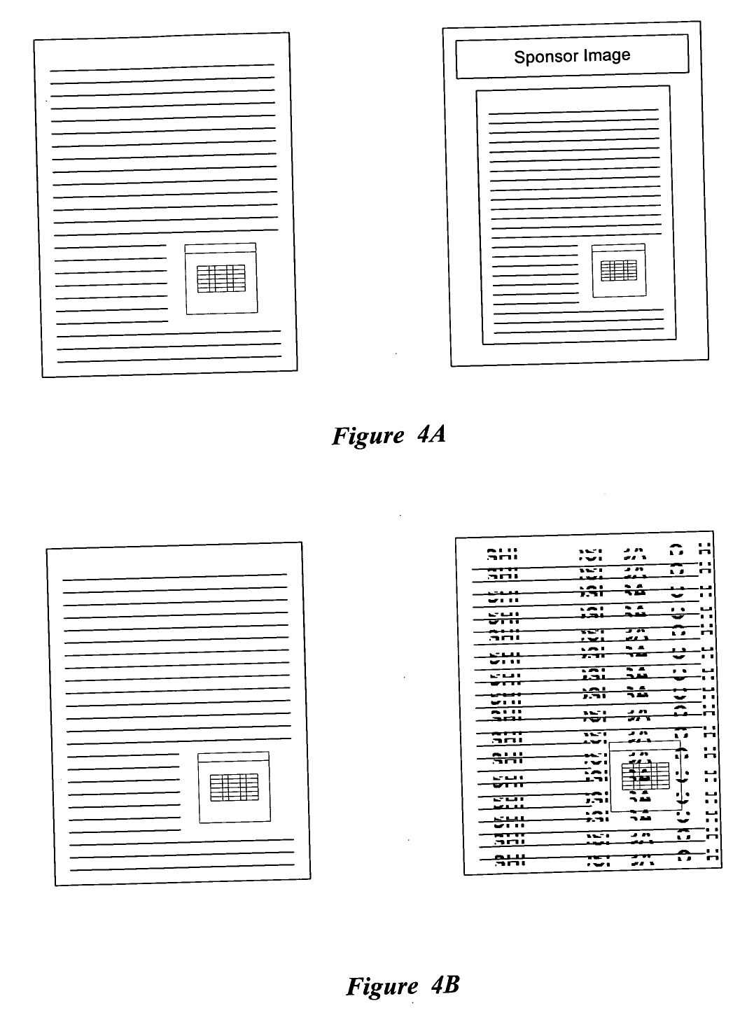

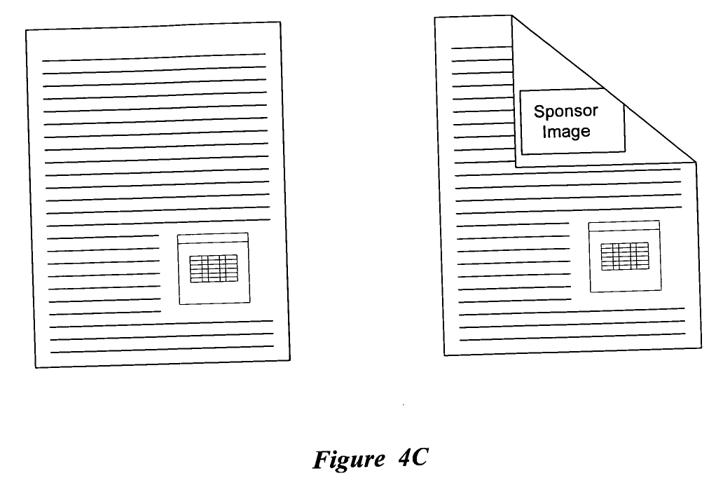

In one embodiment, when the service requested by the associated user is a copy request, the original document is scanned and the sponsor image is inserted into the scanned image data representing the original document. As stated above, the parameters associated with the sponsor indicate the placement on the output copies of the document of the sponsor image, i.e., the advertisement or logo, including a banner advertisement, a watermark advertisement, and a reverse-side advertisement. FIGS. 4A-4C illustrate these positions on the output document, with FIG. 4A illustrating a banner placement, FIG. 4B illustrating a watermark advertisement placement and FIG. 4C illustrating a reverse-side advertisement.

In another embodiment, when the service request is a scan request, the user is then prompted via the interface 108 or the user device 104 to designate a storage location for the scanned image. The retrieved sponsor image is then inserted into the scanned image of the original document according to the sponsor parameters and stored in the designated storage location.

In one embodiment, when the service request is a print service request, the user is prompted for the location of the file to be printed. For example, the electronic file is capable of being stored on removable media, such as a USB drive, a floppy disk, a CD-ROM or DVD-ROM and the like, or alternatively stored on a network drive, such as the backend file storage server 114, an FTP server and the like, or the file to be printed is stored on the local hard disk drive of the user device 104. In each of these circumstances, the user is required to designate the file name and location of the file. Once received, the multifunction peripheral device 102 generates a PostScript® document file using an integrated device driver. It will be understood by those skilled in the art that the driver need not generate a PostScript® file, but any file in a language understood by the printer is acceptable. The skilled artisan will further appreciate that conversion and generation of a file in a suitable printer language need not be performed by the device 102, but rather the user device 104 running an appropriate application, converts the document into printer recognizable form. The PostScript® file is then combined with the sponsor image according to the sponsor parameters and output by the multifunction peripheral device 102.

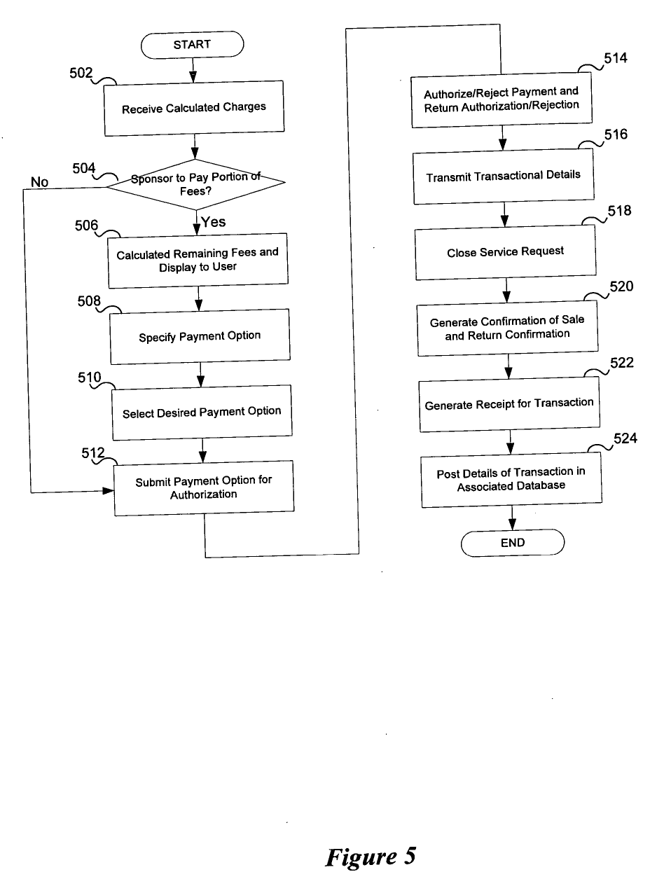

Following performance by the multifunction peripheral device 102 of the document processing service at step 220, flow proceeds to step 222, wherein charges associated with the document processing service are calculated in accordance with the flowchart 500 illustrated in FIG. 5. As shown at step 502, calculated charges are received and a determination is made at step 504 whether the sponsor is to pay part of the fees. Following a positive determination at step 504, flow proceeds to step 506, wherein the remaining amount of fees is calculated and displayed to the user. As will be understood by those skilled in the art, the remaining fees are suitably those fees remaining following partial or no payment for the service by the sponsor. At step 508, the user is prompted to specify a payment option via any suitable means and to provide the necessary information for the associated payment option.

At step 510, the user selects the desired payment option and provides the information required to effectuate such payment via any suitable means. In one embodiment, the selection of the desired payment option includes the use of credit cards, user accounts and cash. At step 512 the system submits the authorization request to the backend database server 110 via any suitable means. At step 514, the authorization request is approved or rejected and such approval or rejection information is transmitted to the multifuctional peripheral device 102 or system 100. Such approval or rejection is based on suitable criteria or processes known in the art. The skilled artisan will appreciate that in the event payment is made in cash, the currency is inserted by the user into the appropriate receptacle and change, if any, is provided using methods and processes known in the art.

Upon approval of the transaction, e.g., acceptance of credit card, then flow proceeds to step 516, wherein the system transmits the transactional details are transmitted to the multifunction peripheral device 102 and/or the user device 104. A close service request is then transmitted, via any suitable means, to the multifunction peripheral device indicating completion of the service request at step 518. Upon receipt of the transaction detail and the request to close the transaction request, the backend database server generates a confirmation and transmits it to the multifuctional peripheral device or system as shown at 520.

At step 522, a receipt for the transaction is generated by the multifuctional peripheral device. The details of the transaction are posted in an associated database via any suitable means for later retrieval as shown at step 524.

Returning to step 504, a determination is made that the sponsor is responsible for the full amount of the service. Flow then proceeds to step 512, wherein the system submits the authorization request to the backend database server 110 via any suitable means. In the preferred embodiment, the sponsor has an account to which the amount of the service is charged. The skilled artisan will appreciate that other methods of charging the sponsors for services are equally capable of being employed by the present invention. At step 514, the authorization request is approved or rejected and such approval or rejection information is transmitted to the multifuctional peripheral device 102 or system 100. Such approval or rejection is based on suitable criteria or processes known in the art.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A method for enabling sponsorship of document processing services comprising the steps of:
receiving, from an associated user, data representative of a selected document processing request to be performed on an associated, electronic document;
identifying each sponsor associated with the received document processing request;
selectively communicating, to the associated user, sponsor data representative of at least one sponsor identified with the selected document processing request;
receiving, from the associated user, document processing instructions for completing the document processing request inclusive of at least one sponsorship activity; and
selectively completing the document processing request in accordance with the at least one sponsorship activity.

2. The method for enabling sponsorship of document processing services of claim 1, further comprising the steps of:
receiving sponsor image data representative of a commercial message associated with the at least one sponsor;
inserting the received sponsor image data into the associated electronic document; and
generating the received sponsor image data as a part of the associated electronic document, wherein the commercial message is at least one of a banner image, a watermark image and a reverse-side image.

3. The method for enabling sponsorship of document processing services of claim 2, wherein the sponsor data includes data representative of at least one parameter associated with the at least one sponsor limiting the document processing request, further comprising the steps of:
comparing the at least one parameter with the submitted document processing request;
generating an authorization signal based upon the comparison, which signal is representative of at least one of an approval and a rejection of the document processing request, wherein the at least one parameter is at least one of a page limit, a size limit, and a color limit.

4. The method for enabling sponsorship of document processing services of claim 3, further comprising the step of calculating a fee associated with the completion of the document processing request.

5. The method for enabling sponsorship of document processing services of claim 4, further comprising the steps of:
receiving partial payment data representative of a partial payment of the calculated fee associated with the at least one sponsor;
calculating remaining fee data representative of the partial payment deducted from the calculated fee; and
receiving, from the associated user, payment data representative of the remaining fee.

6. The method for enabling sponsorship of document processing services of claim 4, further comprising the step of receiving, from the sponsor associated with the at least one sponsorship activity, payment data representative of the payment of the calculated fee.

7. The method for enabling sponsorship of document processing services of claim 4, further comprising the steps of:
in the event of a rejection of the document processing request, selecting, by the user, at least one payment option; and
receiving, from the associated user, payment data representative of the calculated fee.

8. A system for enabling sponsorship of document processing services comprising the steps of:
means adapted for receiving, from an associated user, data representative of a selected document processing request to be performed on an associated, electronic document;
identification means adapted for identifying each sponsor associated with the received document processing request;
communication means adapted for selectively communicating, to the associated user, sponsor data representative of at least one sponsor identified with the selected document processing request;
means adapted for receiving, from the associated user, document processing instructions for completing the document processing request inclusive of at least one sponsorship activity; and
processing means adapted for selectively completing the document processing request in accordance with the at least one sponsorship activity.

9. The system for enabling sponsorship of document processing services of claim 8, further comprising:
means adapted for receiving sponsor image data representative of a commercial message associated with the at least one sponsor;
means adapted for inserting the received sponsor image data into the associated electronic document; and
means adapted for generating the received sponsor image data as a part of the associated electronic document, wherein the commercial message is at least one of a banner image, a watermark image and a reverse-side image.

10. The system for enabling sponsorship of document processing services of claim 9, wherein the sponsor data includes data representative of at least one parameter associated with the at least one sponsor limiting the document processing request, further comprising:
comparison means adapted for comparing the at least one parameter with the submitted document processing request;
generating an authorization signal based upon the comparison, which signal is representative of at least one of an approval and a rejection of the document processing request, wherein the at least one parameter is at least one of a page limit, a size limit, and a color limit.

11. The system for enabling sponsorship of document processing services of claim 10, further comprising calculation means adapted for calculating a fee associated with the completion of the document processing request.

12. The system for enabling sponsorship of document processing services of claim 11, further comprising:
means adapted for receiving partial payment data representative of a partial payment of the calculated fee associated with the at least one sponsor;
calculation means adapted for calculating remaining fee data representative of the partial payment deducted from the calculated fee; and
means adapted for receiving, from the associated user, payment data representative of the remaining fee.

13. The system for enabling sponsorship of document processing services of claim 11, further comprising means adapted for receiving, from the sponsor associated with the at least one sponsorship activity, payment data representative of the payment of the calculated fee.

14. The system for enabling sponsorship of document processing services of claim 10, further comprising:
in the event of a rejection of the document processing request, selection means adapted for selecting, by the user, at least one payment option; and
means adapted for receiving, from the associated user, payment data representative of the calculated fee.

15. A computer-readable medium of instructions with computer-readable instructions stored thereon for method for enabling sponsorship of document processing services comprising the steps of:
instructions for receiving, from an associated user, data representative of a selected document processing request to be performed on an associated, electronic document;
instructions for identifying each sponsor associated with the received document processing request;
instructions for selectively communicating, to the associated user, sponsor data representative of at least one sponsor identified with the selected document processing request;
instructions for receiving, from the associated user, document processing instructions for completing the document processing request inclusive of at least one sponsorship activity; and
instructions for selectively completing the document processing request in accordance with the at least one sponsorship activity.

16. The computer-readable medium of instructions with computer-readable instructions stored thereon for enabling sponsorship of document processing services of claim 15, further comprising:
instructions for receiving sponsor image data representative of a commercial message associated with the at least one sponsor;
instructions for inserting the received sponsor image data into the associated electronic document; and
instructions for generating the received sponsor image data as a part of the associated electronic document, wherein the commercial message is at least one of a banner image, a watermark image and a reverse-side image.

17. The computer-readable medium of instructions with computer-readable instructions stored thereon for enabling sponsorship of document processing services of claim 16, wherein the sponsor data includes data representative of at least one parameter associated with the at least one sponsor limiting the document processing request, further comprising:
instructions for comparing the at least one parameter with the submitted document processing request;
instructions for generating an authorization signal based upon the comparison, which signal is representative of at least one of an approval and a rejection of the document processing request, wherein the at least one parameter is at least one of a page limit, a size limit, and a color limit.

18. The computer-readable medium of instructions with computer-readable instructions stored thereon for enabling sponsorship of document processing services of claim 17, further comprising instructions for calculating a fee associated with the completion of the document processing request.

19. The computer-readable medium of instructions with computer-readable instructions stored thereon for enabling sponsorship of document processing services of claim 18, further comprising:
instructions for receiving partial payment data representative of a partial payment of the calculated fee associated with the at least one sponsor;
instructions for calculating remaining fee data representative of the partial payment deducted from the calculated fee; and
instructions for receiving, from the associated user, payment data representative of the remaining fee.

20. The computer-readable medium of instructions with computer-readable instructions stored thereon for enabling sponsorship of document processing services of claim 18, further comprising instructions for receiving, from the sponsor associated with the at least one sponsorship activity, payment data representative of the payment of the calculated fee.

21. The computer-readable medium of instructions with computer-readable instructions stored thereon for enabling sponsorship of document processing services of claim 18, further comprising:
in the event of a rejection of the document processing request, instructions for selecting, by the user, at least one payment option; and
instructions for receiving, from the associated user, payment data representative of the calculated fee.

22. A computer-implemented method for enabling sponsorship of document processing services comprising the steps of:
receiving, from an associated user, data representative of a selected document processing request to be performed on an associated, electronic document;
identifying each sponsor associated with the received document processing request;
selectively communicating, to the associated user, sponsor data representative of at least one sponsor identified with the selected document processing request;
receiving, from the associated user, document processing instructions for completing the document processing request inclusive of at least one sponsorship activity; and
selectively completing the document processing request in accordance with the at least one sponsorship activity.

23. The computer-implemented method for enabling sponsorship of document processing services of claim 22, further comprising the steps of:
receiving sponsor image data representative of a commercial message associated with the at least one sponsor;
inserting the received sponsor image data into the associated electronic document; and
generating the received sponsor image data as a part of the associated electronic document, wherein the commercial message is at least one of a banner image, a watermark image and a reverse-side image.

24. The computer-implemented method for enabling sponsorship of document processing services of claim 23, wherein the sponsor data includes data representative of at least one parameter associated with the at least one sponsor limiting the document processing request, further comprising the steps of:
comparing the at least one parameter with the submitted document processing request;
generating an authorization signal based upon the comparison, which signal is representative of at least one of an approval and a rejection of the document processing request, wherein the at least one parameter is at least one of a page limit, a size limit, and a color limit.

25. The computer-implemented method for enabling sponsorship of document processing services of claim 24, further comprising the step of calculating a fee associated with the completion of the document processing request.

26. The computer-implemented method for enabling sponsorship of document processing services of claim 25, further comprising the steps of:
receiving partial payment data representative of a partial payment of the calculated fee associated with the at least one sponsor;
calculating remaining fee data representative of the partial payment deducted from the calculated fee; and
receiving, from the associated user, payment data representative of the remaining fee.

27. The computer-implemented method for enabling sponsorship of document processing services of claim 25, further comprising the step of receiving, from the sponsor associated with the at least one sponsorship activity, payment data representative of the payment of the calculated fee.

28. The computer-implemented method for enabling sponsorship of document processing services of claim 25, further comprising the steps of:
in the event of a rejection of the document processing request, selecting, by the user, at least one payment option; and
receiving, from the associated user, payment data representative of the calculated fee.
